(19) United States
(12) Patent Application Publication
(10) Pub. No.: US 2012/0143910 A1
(43) Pub. Date: Jun. 7, 2012

(54) SYSTEM FOR PROCESSING VISUAL INFORMATION AND METHOD THEREOF

(75) Inventors: Byoung-Jun Park, Jeollabuk-do (KR); Sang Hyeob Kim, Daejeon (KR); Myung-Ae Chung, Daejeon (KR); Kyu-Sang Shin, Jeollabuk-do (KR)

(73) Assignee: Electronics and Telecommunications Research Institute, Daejeon (KR)

(21) Appl. No.: 13/312,757

(22) Filed: Dec. 6, 2011

(30) Foreign Application Priority Data
Dec. 7, 2010 (KR) 10-2010-0124377

(51) Int. Cl. G06F 17/30

(52) U.S. Cl. 707/770; 707/E17.014

(57) ABSTRACT

A system for processing visual information and a method thereof. Exemplary embodiments provides to a terminal event information searched through space recognition by a processing server for long-term storing image information input through the terminal so as to match and output event information with the input image information and recognize events that are an object of interest in the input image information or the long-term stored the image information and provide the related information so as to learn interest characteristics of a user and store the interest characteristics in the database, thereby providing user-based information. In addition, the exemplary embodiments of the present invention long-term stores the visual information by processing the visual information through the processing server so as to be used as a black box and can be used for applications requiring various artificial intelligence functions such as a disabled sensory supporting system, a robot, or the like.

### CROSS-REFERENCES TO RELATED APPLICATIONS

The present application claims priority under 35 U.S.C 119(a) to Korean Application No. 10-2010-0124377, filed on Dec. 7, 2010, in the Korean Intellectual Property Office, which is incorporated herein by reference in its entirety set forth in full.

### BACKGROUND

Exemplary embodiments relate to a system for processing visual information and a method thereof, and more particularly, to a system for processing visual information and a method thereof providing event information found through space recognition in a processing server by the terminal for long-term storing image information input so as to match and output the event information with the input image information.

A person obtains about 80 to 90% of sensory information from vision. Visual information processing, out of all functions for human survival and intellectual activity, is the most important function of brain information processing functions.

Therefore, the visual information is the most important recognition and information input means of an intellectual robot technology. In addition, a human interface technology based on a human sensory processing technology is in a stage that decides physical conditions to support new user-based service interface environment. Currently, a development of innovative convergence IT devices has been attempted so as to more improve human convenience by applying emotion/recognition to related products within a category of human engineering.

The above-mentioned technology means a background art of the technology field to which the present invention belongs rather than meaning the related art.

Currently, a need exists for a development of a computing methodology based on human brain-recognition mechanism and a development of a system naturally interacting with human.

An object of the present invention is to provide a system for processing visual information and a method thereof providing to a terminal event information found through space recognition by a processing server for long-term storing image information input through the terminal so as to match and output the event information with the input image information.

The above technology configuration is a background art for helping understanding of the present invention but does not mean the related art well-known in the art to which the present invention pertains.

### SUMMARY

An object of the present invention is to provide a system for processing visual information and a method thereof providing event information found through space recognition in a processing server by the terminal for long-term storing image information input to match and output the event information with the input image information.

An embodiment of the present invention relates to a system for processing visual information, including: a camera device receiving image information; and a terminal short-term storing the image information input from the camera device, transmitting the input image information to a processor server for long-term storing, and receiving event information from the processing server so as to match and output the event information with the image information.

In one embodiment, the terminal may further include the GPS receiving module.

In one embodiment, the processing server may detect, recognize, and search events from the image information transmitted from the terminal and then, transmit the searched event information to the terminal, and long-term store and manage the event information and the transmitted image information in the database.

In one embodiment, the processing server may be connected to Internet for searching the events.

In one embodiment, the event information may include the image information associated with the events and long-term stored in the database.

Another embodiment of the present invention relates to a method for processing visual information, including: performing space recognition on image information input from a camera device and short-term storing the input image information in a terminal; compressing and encoding the short-term stored image information and transmitting the compressed and encoded image information to a processing server; and matching and outputting event information received from the processing server with the input image information.

In one embodiment, the method for processing visual information may further include setting target events before the image information is input from the camera device.

In one embodiment, the method for processing visual information may further include: short-term storing the event information received from the processing server; and searching the short-term stored event information when the event information is not received from the processing server so as to match and output the event information with the input image information.

Another embodiment of the present invention relates to a method for processing visual information, including: recovering and decoding image information transmitted from a terminal to perform space recognition; detecting and recognizing target events in the spatially recognized image information; transmitting event information, found by searching a database, to the terminal when the target events are detected and recognized; and long-term storing searched event information in the database, along with the transmitted image information and managing the found event information as interest events.

In one embodiment, the method for processing visual information may further include detecting and recognizing the interest event to transmit the event information found by searching the database to the terminal, when the target events are not set at the detecting and recognizing of the target events.

In one embodiment, the method for processing visual information may further include searching the target events based on web information when the target events are not found by searching the database.

In one embodiment, the event information may include the image information that is associated with the target event and the interest event and long-term stored in the database.

### BRIEF DESCRIPTION OF THE DRAWINGS

The above and other aspects, features and other advantages will be more clearly understood from the following detailed description taken in conjunction with the accompanying drawings, in which:

FIG. 1 is a block diagram illustrating a configuration for a system for processing visual information in accordance with an embodiment of the present invention;

FIG. 2 is a flow chart for explaining a process for a terminal to process visual information by a method for processing visual information in accordance with an embodiment of the present invention; and

FIG. 3 is a flow chart for explaining a process for a processing server to process visual information by the method for processing visual information in accordance with the embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

In describing the embodiment, a thickness of lines illustrated in the drawings, a size of components, etc., may be exaggeratedly illustrated for clearness and convenience of explanation. In addition, terms described to be below are terms defined in consideration of functions in the present invention, which may be changed according to the intention or practice of a user or an operator. Therefore, these terms will be defined based on contents throughout the specification.

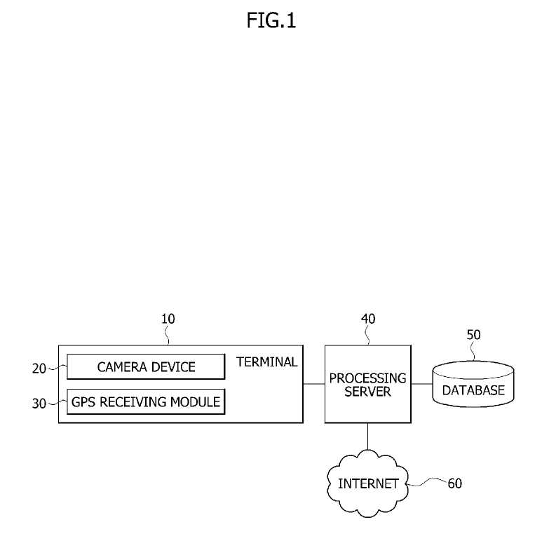

FIG. 1 is a block diagram illustrating a configuration for a system for processing visual information in accordance with an embodiment of the present invention.

As illustrated in FIG. 1, the system for processing visual information in accordance with the embodiment of the present invention includes a camera device 20, a GPS receiving module 30, a terminal 10, a database 50, and a processing server 40.

The camera device 20, a device for receiving image information, may be configured to be integrated with terminal 10 or to be separate from the terminal so as to provide the image information to the terminal 10 by wire or by wireless communication.

The GPS receiving module 30 is a module for acquiring geographical location information of image information photographed by the camera device 10. The GPS receiving module may accurately recognize objects, such as things, buildings, a distance, or the like, in the image information through a space tag provided from the processing server 40 based on the geographical location information when the GPS receiving module performs space recognition in the image information.

The terminal 10 may be a mobile phone, a smart phone, UMPC, or the like, that reacts to short-term memory and reaction among brain functions of a person.

The terminal 10 short-term stores the image information input from the camera device 20 and compresses and encodes the input image information and transmits the compressed and decoded image information to the processing server 40 and receives the event information from the processing server 40 and matches the input image information with the event information so as to be output in various types such as vision, voice, character, vibration, or the like, according to the reaction type, that is, the output type and react to the events.

The processing server 40 is a device that corresponds to a long-term memory among brain functions of a human. The processing server 40 recoveries and decodes the image information transmitted from terminal 10 to detect, recognize, and search the events from the image information; transmits the found event information to the terminal; stores the event information and the transmitted image information for long-term storage in a database 50 to match the event information and the image information so as to meet user's characteristics.

In this case, the event information transmitted to the terminal 10 may be transmitted, including the image information that is associated with the events and long-term stored in the database 50.

In addition, the processing server 40 is connected to Internet 60 so as to search a larger amount of information, when the events are not found in the database 50 at the time of searching the event.

Meanwhile, the processing server 40 may provide a function of searching the image information and the event information long-term stored in the database 50 each time, each date, and each event according to the user demand.

The visual information processing system configured as described above compresses, encodes, and short-term stores the input image information when receiving the image information photographed by the camera device 20 in the terminal 10 and transmits the compressed and encoded image information to the processing server 40 for long-term storing and processing. In this case, the processing server 40 detects and recognizes the user desired events (things, space, characters, or the like) and stores the event information found by searching the database 50 and the Internet 60 in the database 50, together with the image information so that the event information is learned so as to meet the personal properties of the user, transmits the found event information to the terminal 10 to match and output the event information with the input image information, and performs the reaction to the event information.

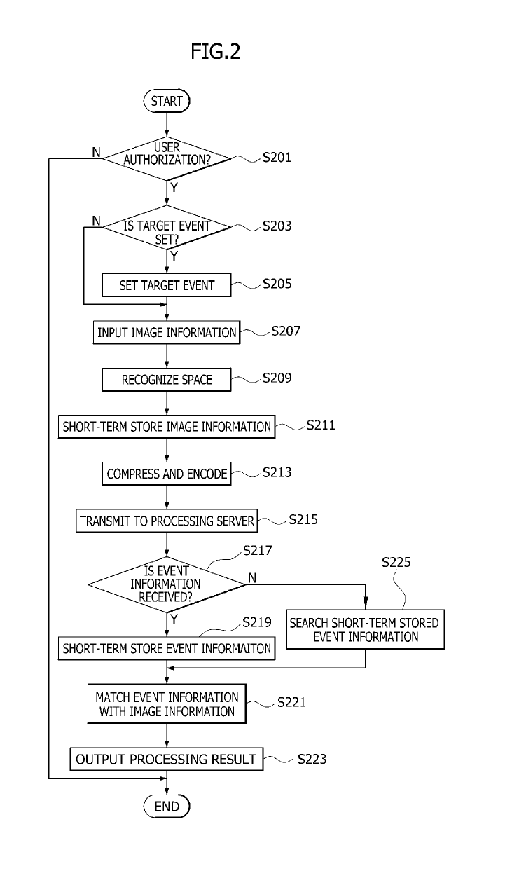

A method for processing visual information in accordance with another embodiment of the present invention will be described with reference to a flow chart in accordance with the embodiment of the present invention illustrated in FIG. 2.

First, as illustrated in FIG. 2, the method for processing visual information in accordance with the embodiment of the present invention will be described based on the method of processing visual information in the terminal.

The terminal 10 performs user authentication for processing visual information (S201). In this case, when the user authentication is not performed, the visual information processing ends.

After performing the user authentication, target events to be searched by a user may be set through image information (S203) (S205).

When the user authentication completes, the image information is received from the camera device 20 (S207).

The space tag for objects, such as things, buildings, or distance, or the like, is recognized in the image information based on the space tag provided from the processing server 40 by performing the space recognition for the image information input later (S209).

In this case, the space tag may be more accurately recognized when using the geographical location information of the area photographed by the GPS receiving module 30.

Next, the image information input to the terminal 10 is short-term stored (S211).

The short-term stored image information is compressed and encoded (S213) so as to be transmitted to the processing server 40 (S215).

Thereafter, it is determined whether the event information found from the processing server 40 is received (S217). When the event information is received, the received event information is short-term stored and then, the received event information matches the space information, according to the space tag of the spatially recognized image information (S219) (S221).

As described above, the event information and the image information are matched with each other and outputted through visual, auditory, tactile means, or the like, according to an event information, such that the processing results are transmitted to the user (S223).

Meanwhile, when the event information is not received from the processing server 40 due to a problem, such as a communication disturbance with the processing server 40, or the like (S217), the short-term stored event information is searched, which may be outputted by being matched with the input image information (S225) (S221).

As described above, even though the event information is not received from the processing server 40 by the communication disturbance, minimal information may be provided based on the short-stored event information.

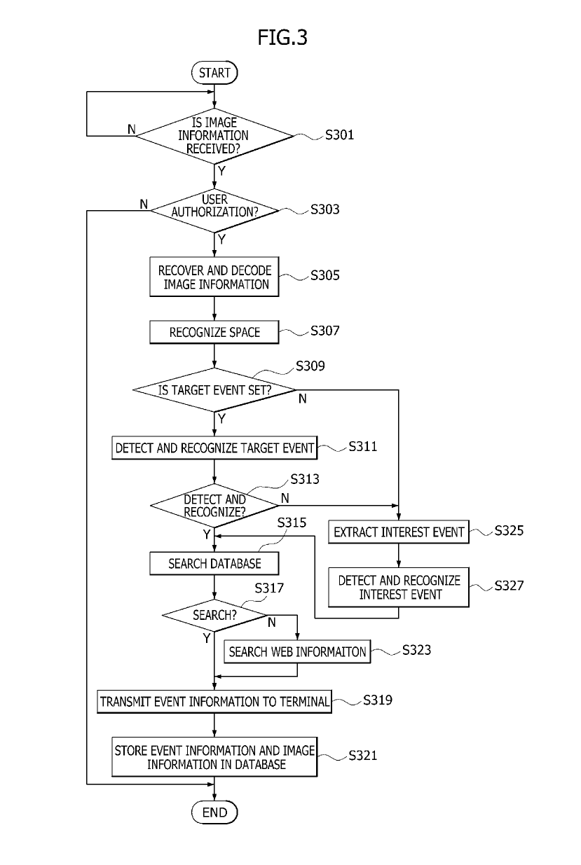

A method for processing visual information in accordance with another embodiment of the present invention will be described with reference to the flow chart for describing the method for processing visual information in accordance with the embodiment of the present invention illustrated in FIG. 3.

First, as illustrated in FIG. 3, the method for processing visual information in accordance with the embodiment of the present invention will be described based on the method of processing visual information in the processing server.

The processing server 40 determines whether the image information is received from the terminal 10 (S301).

In the case where image information is received, a user authentication is performed for the terminal 10. When the user authentication has not been completed, the process ends without processing the visual information (S303).

In the case when the user registration is previously performed for the user authentication, the user profile or the interest events may be registered at the time of the user registration.

When the above-mentioned user authentication completes, the transmitted image information is recovered and decoded (S305).

Next, space recognition for image information is performed (S307). In this case, the detailed space recognition is performed based on a high processing rate and a vast amount of data in the processing server 40, thereby recognizing the space tag for the objects such as things, buildings, or a distance, or the like, in the image information.

In this case, the space tag may be more accurately recognized when using the geographical location information of the area photographed by the GPS receiving module 30.

After space recognition is recognized, it is determined whether the target events are set (S309).

In this case, when the target events are set, the target events are detected and recognized in the spatially recognized image information (S311).

The target events input from the user may be set before the image information is input from the camera device 20 in the terminal 10.

In this case, when the target events are detected and recognized, the target events are searched in the database 50 (S313) (S315).

As described above, when the target events are found by searching the target events in the database 50, the searched event information is transmitted to the terminal 10 (S317) (S319).

In this case, the event information may include the long-term stored image information associated with the target events.

However, when the target events are not found even when the database is searched (S317), the target events are searched based on web information through the Internet 60 (S323) and the found event information is transmitted to the terminal 10 (S319).

As described above, the found event information is long-term stored in the database 50, along with transmitted image information and is managed as the interest events, and is learned and databased so as to meet the user by repeating the process (S321).

Meanwhile, when the target events are not defined (S309), the interest events managed in the database 50 are extracted and are detected and recognized in the spatially recognized image information (S325) (S327).

In addition, the interest events of the user may also be extracted based on the user profile.

When the interest events are detected and recognized, the interest events are searched in the database (S315).

As described above, when the interest events are found by searching the interest event in the database 50, the found event information is transmitted to the terminal 10 (S317) (S319).

In this case, the event information may include the long-term stored image information associated with the target events.

However, when the interest events are not found even though the database is searched (S317), the event information is searched based on web information through the Internet 60 (S323) and the found event information is transmitted to the terminal 10 (S319).

As described above, the found event information is long-term stored in the database 50, along with the input image information and is managed as the interest event, and is learned and databased so as to meet the user by repeating the process (S321).

As set forth above, the exemplary embodiments of the present invention can provide to the terminal the event information searched through the space recognition by the processing server for long-term storing the image information input through the terminal so as to match and output the event information with the input image information and recognize the events that are the object of interest in the input image information or the long-term stored image information and provide the related information so as to learn the interest characteristics of the user and store the interest characteristics in the database, thereby providing the user-based information.

In addition, the exemplary embodiments of the present invention can long-term store the visual information by processing the visual information through the processing server so as to be used as the black box and can be used for applications requiring various artificial intelligence functions such as the disabled sensory supporting system, the robot, or the like.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A system for processing visual information, comprising:
a camera device receiving image information; and
a terminal short-term storing the image information input from the camera device, transmitting the input image information to a processor server for long-term storing, and receiving event information from the processing server so as to match and output the event information with the image information.

2. The system of claim 1, wherein the terminal further includes the GPS receiving module.

3. The system of claim 1, wherein the processing server detects, recognizes, and searches events from the image information transmitted from the terminal and then, transmits the found event information to the terminal, and long-term stores and manages the event information and the transmitted image information in the database.

4. The system of claim 3, wherein the processing server is connected to Internet for searching the events.

5. The system of claim 3, wherein the event information includes the image information associated with the events and long-term stored in the database.

6. A method for processing visual information, comprising:
performing space recognition on image information input from a camera device and short-term storing the input image information in a terminal;
compressing and encoding the short-term stored image information and transmitting the compressed and encoded image information to a processing server; and
matching and outputting event information received from the processing server with the input image information.

7. The method of claim 6, further comprising setting target events before the image information is input from the camera device.

8. The method of claim 6, further comprising:
short-term storing the event information received from the processing server; and
searching the short-term stored event information when the event information is not received from the processing server to match and output the event information with the input image information.

9. A method for processing visual information, comprising:
recovering and decoding image information transmitted from a terminal to perform space recognition;
detecting and recognizing target events from the spatially recognized image information;
transmitting event information found by searching a database to the terminal when the target events are detected and recognized; and
long-term storing the found event information in the database, along with the transmitted image information and managing the found event information as interest events.

10. The method of claim 9, further comprising detecting and recognizing the interest event to transmit the event information found by searching the database to the terminal, when the target events are not set at the step of detecting and recognizing of the target events.

11. The method of claim 9, further comprising searching the target events based on web information when the target events are not found by searching the database.

12. The method of claim 9, wherein the event information includes the image information that is associated with the target event and the interest event and long-term stored in the database.
